(19) United States
(12) Patent Application Publication
(10) Pub. No.: US 2025/0306496 A1
(43) Pub. Date: Oct. 2, 2025

(54) IMAGE FORMING APPARATUS

(71) Applicant: FUJIFILM Business Innovation Corp., Tokyo (JP)

(72) Inventors: Kaito ITOKAWA, Kanagawa (JP); Yuta HOSHINO, Kanagawa (JP)

(73) Assignee: FUJIFILM Business Innovation Corp., Tokyo (JP)

(21) Appl. No.: 18/817,268

(22) Filed: Aug. 28, 2024

(30) Foreign Application Priority Data
Mar. 26, 2024 (JP) 2024-050430

(51) Int. Cl. G03G 15/02; G03G 15/00; G03G 15/01

(52) U.S. Cl. CPC G03G 15/02; G03G 15/0121; G03G 15/0189; G03G 15/80

(57) ABSTRACT

An image forming apparatus includes: a first charging unit that charges a first image holding body by applying a voltage in which an AC component has a first frequency to the first image holding body; a first developing unit that develops a latent image formed on the first image holding body by using a reference-color toner; a second charging unit that charges a second image holding body by applying a voltage in which an AC component has a second frequency different from the first frequency to the second image holding body; and a second developing unit that develops a latent image formed on the second image holding body by using a special-color toner.

### CROSS-REFERENCE TO RELATED APPLICATIONS

This application is based on and claims priority under 35 USC 119 from Japanese Patent Application No. 2024-050430 filed Mar. 26, 2024.

### BACKGROUND

### (i) Technical Field

The present disclosure relates to an image forming apparatus.

### (ii) Related Art

JP2004-184573A discloses an AC bias application device that applies an AC bias to a plurality of imaging units included in an electrophotographic apparatus. In the AC bias application device, in a case where an AC frequency to be applied to the plurality of units has a value obtained by multiplying an odd number by an integer, an AC bias is applied with peaks of phases or peaks and valleys of phases.

### SUMMARY

Aspects of non-limiting embodiments of the present disclosure relate to an image forming apparatus capable of improving an image quality of an output image in a configuration in which latent images formed on a plurality of image holding bodies are respectively developed by using a reference-color toner and a special-color toner, as compared with a case where a frequency of an AC component of a voltage to be applied to a charging unit that charges each of the image holding bodies is the same.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a first charging unit that charges a first image holding body by applying a voltage in which an AC component has a first frequency to the first image holding body; a first developing unit that develops a latent image formed on the first image holding body by using a reference-color toner; a second charging unit that charges a second image holding body by applying a voltage in which an AC component has a second frequency different from the first frequency to the second image holding body; and a second developing unit that develops a latent image formed on the second image holding body by using a special-color toner.

### BRIEF DESCRIPTION OF THE DRAWINGS

Exemplary embodiment(s) of the present invention will be described in detail based on the following figures, wherein:

FIG. 1 is a schematic view illustrating a configuration of an image forming apparatus according to a first exemplary embodiment when viewed from a front side;

FIG. 2 is a schematic view illustrating a configuration of a connection relationship between a developing device, a charging device, and a power supply according to the first exemplary embodiment when viewed from a rear surface side;

FIG. 3 is a diagram comparing frequencies of applied voltages for each productivity level in the developing device and the charging device according to the first exemplary embodiment;

FIG. 4 is a schematic view illustrating a configuration of an image forming apparatus according to a second exemplary embodiment when viewed from a front side;

FIG. 5 is a schematic view illustrating a configuration of a connection relationship between a developing device, a charging device, and a power supply according to the second exemplary embodiment when viewed from a rear surface side; and

FIG. 6A is a cross-sectional view taken along a line S6-S6, and FIG. 6B is a modification example of FIG. 6A.

### DETAILED DESCRIPTION

Hereinafter, exemplary embodiments of the present invention will be described in detail with reference to the accompanying drawings. In the following description, it is assumed that a direction indicated by an arrow UP in the drawings is referred to as a vertically upward direction and that a direction indicated by an arrow DW is referred to as a vertically downward direction. In addition, it is assumed that a direction indicated by an arrow LH is referred to as a horizontal direction and an apparatus left direction and that a direction indicated by an arrow RH is referred to as a horizontal direction and an apparatus right direction. It is noted that these arrows are set for convenience of description and the orientation of the apparatus does not necessarily match with the arrows.

### First Exemplary Embodiment

Hereinafter, an image forming apparatus according to a first exemplary embodiment will be described.

### Overall Configuration

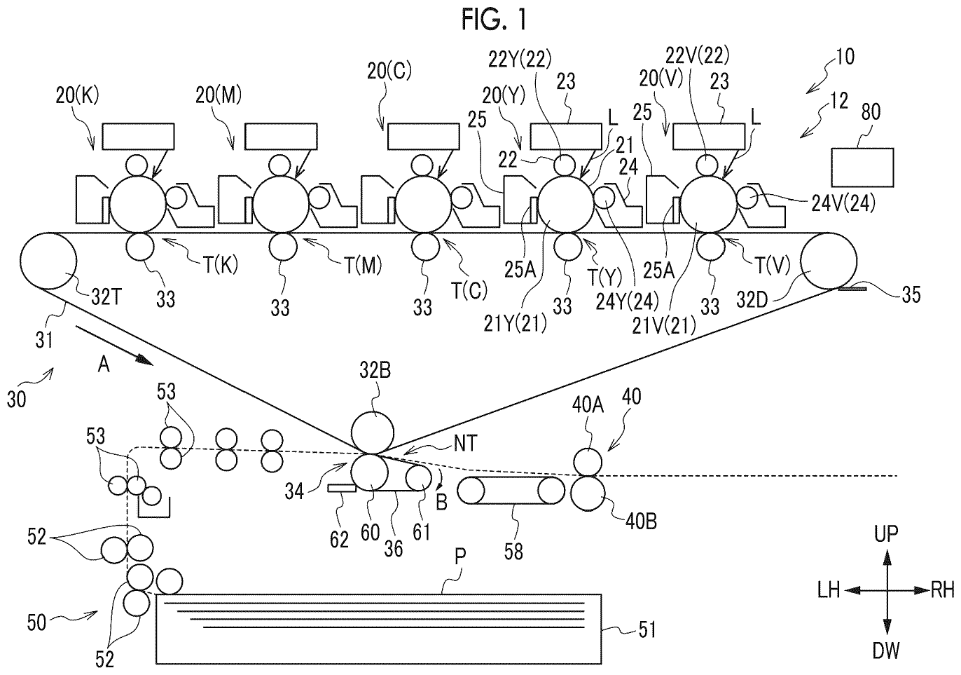

FIG. 1 is a schematic view illustrating a configuration of an image forming apparatus 10 according to a first exemplary embodiment when viewed from a front side. As illustrated in FIG. 1, the image forming apparatus 10 includes a transport device 50, an image forming unit 12, a power supply 68, and a control unit 80 that controls an operation of each unit of the image forming apparatus 10.

### Transport Device

As illustrated in FIG. 1, the transport device 50 transports paper P. The transport device 50 includes a container 51 in which the paper P is contained, and a plurality of transport rolls 52 and 53 that transport the paper P from the container 51 to a secondary transfer position NT. Further, the transport device 50 includes a transport belt 58 that transports the paper P from the secondary transfer position NT to a fixing device 40 to be described below.

### Image Forming Unit

The image forming unit 12 forms an image on the paper P by an electrophotographic method. The image forming unit 12 includes a toner image forming unit 20, a transfer device 30, and a fixing device 40.

### Toner Image Forming Unit

The toner image forming unit 20 forms a toner image. A plurality of the toner image forming units 20 are provided to form toner images for each color. In the first exemplary embodiment, reference-color toner image forming units 20 (20(Y), 20(C), 20(M), and 20(K)) for total four colors of yellow (Y), cyan (C), magenta (M), and black (K) are provided. In addition, in the first exemplary embodiment, in addition to the reference-color toner image forming units 20, a special-color toner image forming unit 20 (20(V)) for one color of gold, silver, custom red, fluorescent pink, clear, white, or the like is provided.

The reference-color toner image forming units 20 (20(Y), 20(C), 20(M), and 20(K)) are disposed in the order of yellow (Y), cyan (C), magenta (M), and black (K) in the apparatus right-left direction from an upstream side to a downstream side in a transport direction of an intermediate transfer belt 31 to be described below. In addition, the special-color toner image forming unit 20 (20(V)) is disposed to be closer to the upstream side (the apparatus right direction) with respect to the yellow (Y) toner image forming unit 20(Y) in the transport direction of the intermediate transfer belt 31.

(Y), (C), (M), (K), and (V) illustrated in FIG. 1 indicate components corresponding to the respective colors. It is noted that, in the description of the present specification, (Y), (C), (M), (K), and (V) may be described as Y, M, C, K, and V without parentheses.

The toner image forming units 20 for the respective colors have the basically same configuration except for a toner to be used. Specifically, the toner image forming units 20 for the respective colors include a photosensitive drum 21 that rotates in a clockwise direction indicated by an arrow, a charging device 22, an exposure device 23, a developing device 24, and a cleaning device 25.

The charging device 22 charges a surface (a photosensitive layer) of the photosensitive drum 21 to a negative polarity by applying a voltage in which an AC component is superimposed on a DC component. The charging device 22 includes a charging roll.

For example, in the reference-color toner image forming unit 20(Y), the charging device 22Y charges the surface of the photosensitive drum 21Y, and in the special-color toner image forming unit 20(V), the charging device 22V charges the surface of the photosensitive drum 21V. The charging device 22Y and the charging device 22V are respectively examples of a first charging unit and a second charging unit. In addition, the photosensitive drum 21Y and the photosensitive drum 21V are respectively examples of a first image holding body and a second image holding body.

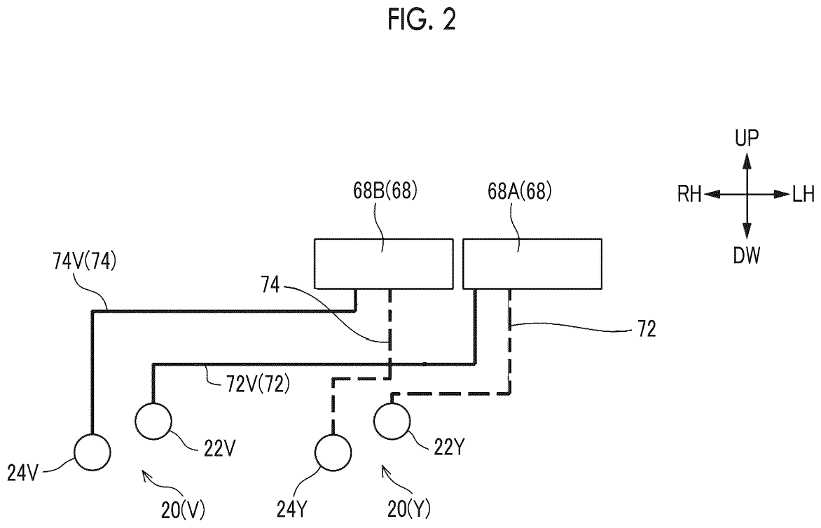

As illustrated in FIG. 2, power is supplied from the power supply 68 to the charging device 22. The power supply 68 will be described later.

The exposure device 23 forms an electrostatic latent image on the photosensitive drum 21 by exposing the surface of the photosensitive drum 21 that is charged to a negative polarity by the charging device 22. Specifically, by causing a portion of the surface of the photosensitive drum 21 that is irradiated with exposure light L to exhibit a positive polarity, the exposure device 23 forms an electrostatic latent image on the surface of the photosensitive drum 21. The electrostatic latent image is an example of a latent image.

The developing device 24 forms a toner image by developing the electrostatic latent image formed on the photosensitive drum 21. In the present exemplary embodiment, the electrostatic latent image is developed by a voltage in which an AC component is superimposed on a DC component. The developing device 24 includes a developing roll.

For example, in the reference-color toner image forming unit 20(Y), the developing device 24Y forms a yellow toner image by developing the electrostatic latent image formed on the photosensitive drum 21Y, and in the special-color toner image forming unit 20(V), the developing device 24V forms a special color toner image by developing the electrostatic latent image formed on the photosensitive drum 21V. The developing device 24Y and the developing device 24V are respectively examples of a first developing unit and a second developing unit.

As illustrated in FIG. 2, power is supplied from the power supply 68 to the developing device 24. The power supply 68 will be described later.

The cleaning device 25 removes the toner remaining on the surface of the photosensitive drum 21 after the toner image is transferred to the transfer device 30. The cleaning device 25 includes a blade 25A. The blade 25A comes into contact with the surface of the photosensitive drum 21, and scrapes off the toner remaining on the surface of the photosensitive drum 21.

As described above, in the toner image forming unit 20, the toner image is formed on the surface (the outer circumferential surface) of the photosensitive drum 21.

### Transfer Device

The transfer device 30 transfers the toner image formed by the toner image forming unit 20 onto the paper P. The transfer device 30 performs primary transfer by superimposing, on the intermediate transfer belt 31, the toner images of the photosensitive drums 21 for the respective colors, and performs secondary transfer by superimposing, on the paper P, the superimposed toner images at a secondary transfer position NT. Specifically, the transfer device 30 includes an intermediate transfer belt 31, primary transfer rolls 33, and a secondary transfer unit 34.

### Intermediate Transfer Belt

As illustrated in FIG. 1, the intermediate transfer belt 31 is formed in an endless shape, and is wound around a driving roll 32D, a tension applying roll 32T, and a facing roll 32B such that the orientation is determined. In the first exemplary embodiment, the intermediate transfer belt 31 is oriented in an inverted obtuse triangle shape that is long in the apparatus right-left direction when viewed from the front. It is noted that the intermediate transfer belt 31 may include another roll around which the intermediate transfer belt 31 is wound.

The driving roll 32D causes the intermediate transfer belt 31 to circulate in a direction of an arrow A by a motive power of a motor (not illustrated). The intermediate transfer belt 31 circulates in the direction of the arrow A to transport the toner images, which are obtained by performing the primary transfer, to the secondary transfer position NT. As an example, the driving roll 32D is disposed on the upstream side with respect to the five primary transfer rolls 33 in the circulation direction of the intermediate transfer belt 31. The tension applying roll 32T applies tension to the intermediate transfer belt 31.

In addition, the facing roll 32B is a roll that faces a secondary transfer roll 60 to be described below. The intermediate transfer belt 31 is oriented in an inverted obtuse triangle shape as described above, and the apex of the intermediate transfer belt 31, which is on a lower end side and forms an obtuse angle, is wound around the facing roll 32B. The intermediate transfer belt 31 comes into contact with the photosensitive drums 21 for the respective colors from below, in an upper side portion extending in the apparatus right-left direction with the orientation described above.

A cleaning device 35 that removes the toner remaining on the intermediate transfer belt 31 is provided on the downstream side with respect to the secondary transfer position NT and on the upstream side with respect to the primary transfer positions T (K) in the circulation direction of the intermediate transfer belt 31.

### Primary Transfer Roll

As illustrated in FIG. 1, the primary transfer rolls 33 are rolls that transfer the toner images of the respective photosensitive drums 21 to the intermediate transfer belt 31, and are disposed on an inner side of the intermediate transfer belt 31. The primary transfer rolls 33 are disposed to face the corresponding photosensitive drums 21 for the respective colors with the intermediate transfer belt 31 interposed therebetween. In addition, a primary transfer voltage having a polarity opposite to the toner polarity is applied to the primary transfer rolls 33 by a power supply unit (not illustrated). By applying the primary transfer voltage, the toner images formed on the photosensitive drums 21 are transferred to the intermediate transfer belt 31 at the primary transfer positions T between the photosensitive drums 21 and the primary transfer rolls 33.

### Secondary Transfer Unit

As illustrated in FIG. 1, the secondary transfer unit 34 includes a secondary transfer belt 36, a secondary transfer roll 60, a driven roll 61, a facing roll 32B, and a cleaning device 62. In addition, the secondary transfer unit 34 includes a contact roll (not illustrated) that comes into contact with the facing roll 32B to supply power to the facing roll 32B. In the secondary transfer unit 34, a transfer electric field is formed by applying a voltage in which an AC component is superimposed on a DC component between the facing roll 32B and the secondary transfer roll 60 by the contact roll. By the transfer electric field, the toner images superimposed on the intermediate transfer belt 31 are transferred onto the paper P that is transported between the intermediate transfer belt 31 and the secondary transfer belt 36.

The secondary transfer belt 36 is formed in an endless shape, and is wound around the secondary transfer roll 60 and the driven roll 61. The secondary transfer roll 60 supports the secondary transfer belt 36 such that the secondary transfer belt 36 can circulate, and is rotationally driven by a motor (not illustrated). As the secondary transfer belt 36 moves and circulates, the driven roll 61 is driven.

The secondary transfer roll 60 is disposed to interpose the intermediate transfer belt 31 and the secondary transfer belt 36 between the secondary transfer roll 60 and the facing roll 32B to be described below, and the secondary transfer belt 36 and the intermediate transfer belt 31 are in contact with each other with a predetermined load. A position between the secondary transfer belt 36 and the intermediate transfer belt 31 that are in contact with each other is referred to as a secondary transfer position NT. The paper P is appropriately supplied from the container 51 to the secondary transfer position NT. As the secondary transfer roll 60 is rotationally driven, the secondary transfer belt 36 moves and circulates in a direction of an arrow B.

The facing roll 32B faces the secondary transfer roll 60 via the intermediate transfer belt 31 and the secondary transfer belt 36.

The cleaning device 62 removes the toner on the surface of the secondary transfer belt 36.

### Fixing Device 40

The fixing device 40 heats and presses the toner images transferred onto the paper P to fix the toner images to the paper P. The fixing device 40 includes a heating roll 40A and a pressure roll 40B that is pressed against the heating roll 40A. The paper P onto which the toner images are transferred passes through a nip portion between the heating roll 40A and the pressure roll 40B, and thus, the toner images are fixed to the paper P.

### Power Supply

As illustrated in FIG. 2, the power supply 68 supplies power to at least the toner image forming units 20 of the image forming unit 12. Specifically, the power supply 68 applies a voltage in which an AC component having a specific frequency is superimposed on a DC component to the charging device 22 and the developing device 24. It is noted that, in FIG. 2, for convenience of the description, the reference-color toner image forming units 20(M), 20(C), and 20(K) other than the reference-color toner image forming unit 20(Y) and the special-color toner image forming unit 20(V) are not illustrated.

The power supply 68 is supported by a housing (not illustrated) of the image forming apparatus 10 on a rear surface side of the image forming apparatus 10. The power supply 68 is connected to the respective toner image forming units 20 via wiring lines 72 and 74.

The power supply 68 includes a power supply 68A and a power supply 68B. The power supply 68A is connected to the charging device 22V via the wiring line 72V (72), and the power supply 68B is connected to the developing device 24V via the wiring line 74V (74). The wiring line 72V and the wiring line 74V are respectively examples of a first wiring line and a second wiring line.

The wiring line 72V and the wiring line 74V are respectively supported by the housing of the image forming apparatus 10. For example, the wiring line 72V and the wiring line 74V are supported by a plurality of band clips in the housing.

### Frequency Related to Charging

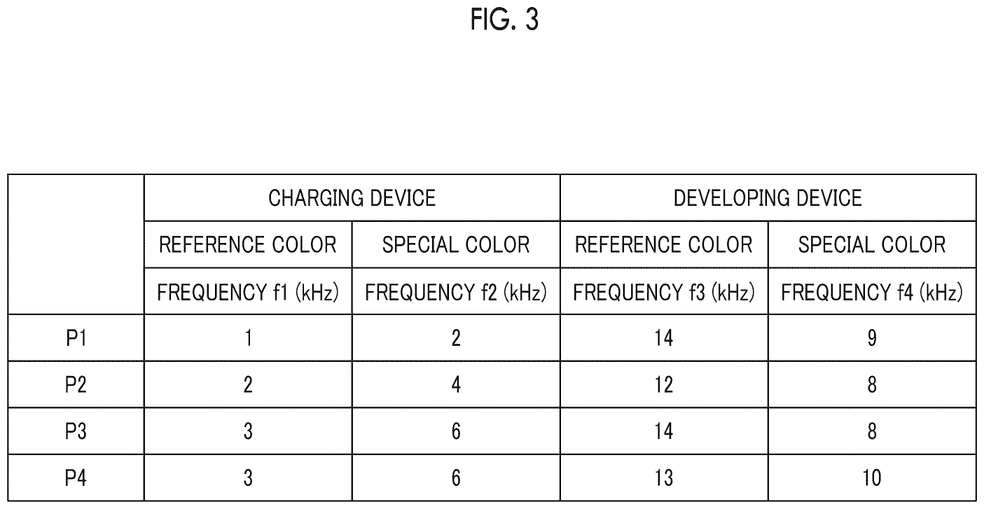

FIG. 3 illustrates frequencies f1 to f4 which are set for productivity levels P1, P2, P3, and P4 different from each other in terms of the number of sheets obtained by performing image formation per unit time in the image forming apparatus 10. It is noted that the productivity level increases from P1 to P4.

First, the charging device 22 will be described. As illustrated in FIG. 3, in any of the productivity levels P1, P2, P3, and P4, a frequency f1 of the voltage applied to the charging device 22Y is different from a frequency f2 of the voltage applied to the charging device 22V. The frequency f1 and the frequency f2 are respectively examples of a first frequency and a second frequency. Specifically, the frequency f2 is set to be higher than the frequency f1. For example, while the frequency f1 is 1 kHz to 3 kHz, the frequency f2 is 2 kHz to 6 kHz. The frequency f2 is set to be higher than the frequency f1 in any of the corresponding productivity levels P1, P2, P3, and P4.

### Frequency Related to Developing

Next, the developing device 24 will be described. As illustrated in FIG. 3, in any of the productivity levels P1, P2, P3, and P4, a frequency f3 of the voltage applied to the developing device 24Y is different from a frequency f4 of the voltage applied to the developing device 24V. The frequency f3 and the frequency f4 are respectively examples of a third frequency and a fourth frequency. Specifically, the frequency f4 is set to be lower than the frequency f3. For example, while the frequency f3 is 12 kHz to 14 kHz, the frequency f4 is 9 kHz to 10 kHz. The frequency f4 is set to be lower than the frequency f3.

### Actions and Effects

Next, actions and effects of the first exemplary embodiment will be described.

The image forming apparatus 10 includes the charging device 22Y that charges the photosensitive drum 21Y by applying a voltage in which an AC component has a frequency f1 to the photosensitive drum 21Y, the developing device 24Y that develops a latent image formed on the photosensitive drum 21Y by using a reference-color toner, the charging device 22V that charges the photosensitive drum 21V by applying a voltage in which an AC component has a frequency f2 different from the frequency f1 to the photosensitive drum 21V, and the developing device 24V that develops a latent image formed on the photosensitive drum 21V by using a special-color toner. According to this configuration, in a configuration in which the electrostatic latent images formed on the plurality of photosensitive drums 21 are respectively developed with the reference-color toner and the special-color toner, an image quality of the output image is improved as compared with a case where the frequencies of the AC components of the voltages applied to the charging units for charging the photosensitive drums for the reference color and the special color are the same.

In addition, as the frequency of the voltage applied to the charging device is relatively high, a deterioration in image quality of the output image, such as moire, can be prevented. On the other hand, the wear of the photosensitive body charged by the charging device is increased. In addition, in the special-color toner, a wear rate of the photosensitive drum is relatively low. Therefore, in the image forming apparatus 10, the charging device 22V applies a voltage having the frequency f2 higher than the frequency f1 to the photosensitive drum 21V. According to this configuration, the image quality of the output image is improved while preventing the wear of the photosensitive drum 21Y as compared with a case where the frequency f1 is higher than the frequency f2.

Further, in the image forming apparatus 10, the developing device 24Y develops the electrostatic latent image by applying a voltage in which an AC component has a frequency f3, and the developing device 24V develops the electrostatic latent image by applying a voltage in which an AC component has a frequency f4 different from the frequency f3. According to this configuration, as compared with the configuration in which the frequency f3 and the frequency f4 are the same, wear of the photosensitive drum 21Y or the photosensitive drum 21V is prevented.

For the purpose of avoiding background fogging, the frequency of the voltage applied to the developing device is set to be relatively high. In a case where the frequency in developing with the special-color toner is relatively high, a corresponding power supply is required, and as a result, a degree of freedom in selecting the power supply is limited. Therefore, in the image forming apparatus 10, the developing device 24V develops the latent image by applying a voltage having a frequency f4 lower than the frequency f3. According to this configuration, as compared with a case where the frequency f3 is lower than the frequency f4, a degree of freedom in selecting the power supply 68B for applying a voltage to the developing device 24V is increased while the wear of the photosensitive drum 21Y is prevented.

### Second Exemplary Embodiment

Next, an image forming apparatus according to a second exemplary embodiment will be described. It is noted that the identical reference numerals are assigned to the identical components of the first exemplary embodiment described above, and the description thereof will be omitted as appropriate.

### Overall Configuration

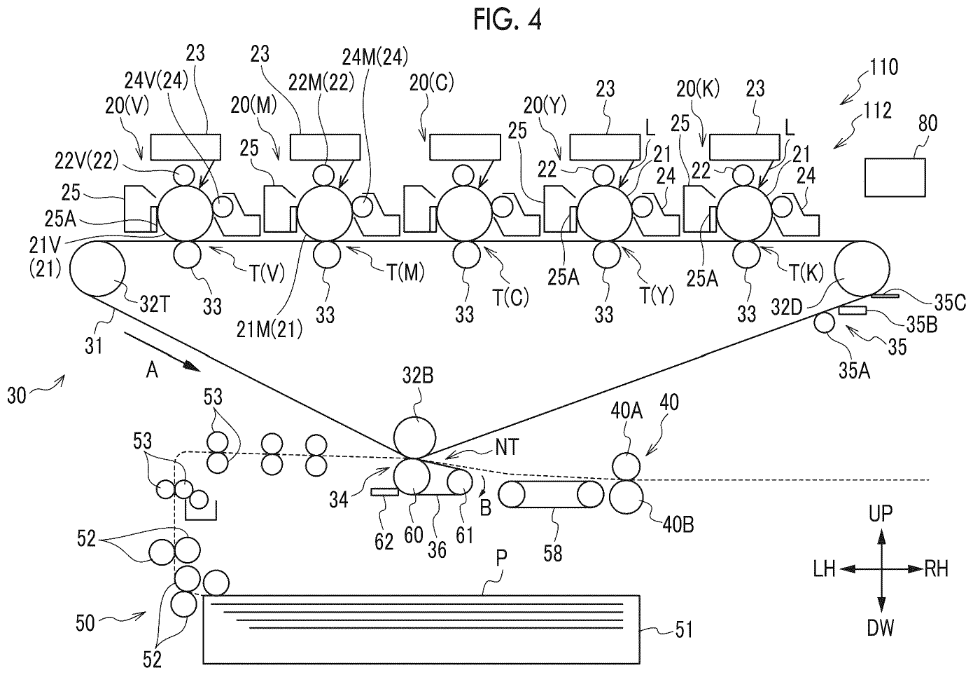

As illustrated in FIG. 4, in the image forming apparatus 110, an image is formed by the image forming unit 112. In a case where the image is formed, a black toner image, a yellow toner image, a cyan toner image, a magenta toner image, and a special color toner image are superimposed and transferred onto the intermediate transfer belt 31 in this order (in the apparatus right-left direction) by the toner image forming units 20 for the reference color and the special color. In addition, the toner images for the respective colors that are formed on the intermediate transfer belt 31 are transferred onto the paper P by the secondary transfer unit 34. It is noted that the positions for the reference color and the special color can be changed by setting of the user.

In addition, in the image forming apparatus 110, a position of the special-color toner image forming unit 20 (20(V)) in the image forming unit 112 is different from the position in the first exemplary embodiment, and the positions of the wiring line 72 and the wiring line 74 that are supported by the housing of the image forming unit 112 are different.

Further, in the image forming apparatus 110, a shielding material 70 is disposed around the wiring line 74. The shielding material 70 will be described later.

Other configurations of the image forming apparatus 110 are the same as the configurations of the image forming apparatus 10 according to the first exemplary embodiment.

### Shielding Material

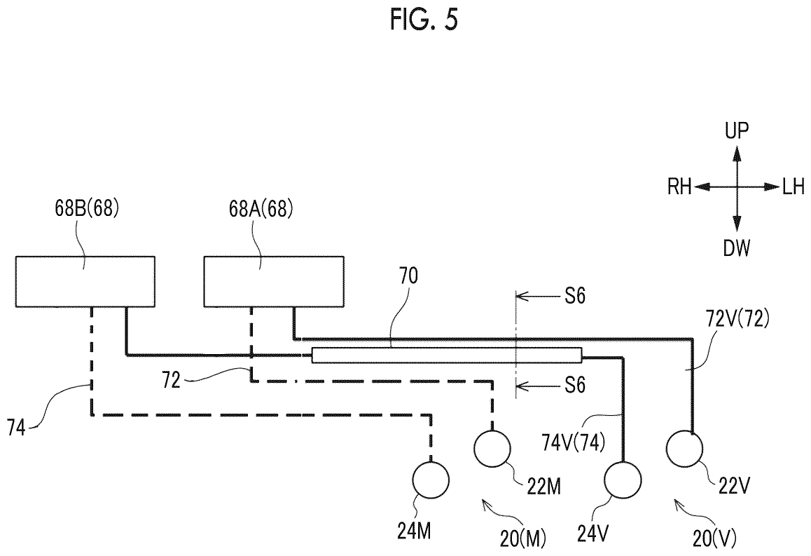

As illustrated in FIG. 5, the shielding material 70 is disposed on a part of the wiring line 74. Specifically, the shielding material 70 is disposed on the wiring line 74V that connects the developing device 24V of the special-color toner image forming unit 20(V) and the power supply 68B. In addition, the shielding material 70 is disposed on a part of a section in which the wiring line 72V and the wiring line 74V are disposed to extend in the apparatus right-left direction.

On the other hand, the shielding material 70 is not wound around the wiring line 72V that connects the charging device 22V of the special-color toner image forming unit 20(V) and the power supply 68A. That is, the shielding material 70 is disposed between the wiring line 72V and the wiring line 74V, and shields the wiring line 74V by separating the wiring line 74V from the wiring line 72V by a distance which is equal to or longer than a predetermined distance. The shielding material 70 is an example of a spacer. In addition, a positional relationship between the shielding material 70, the wiring line 72V, and the wiring line 74V is an example of a separation structure.

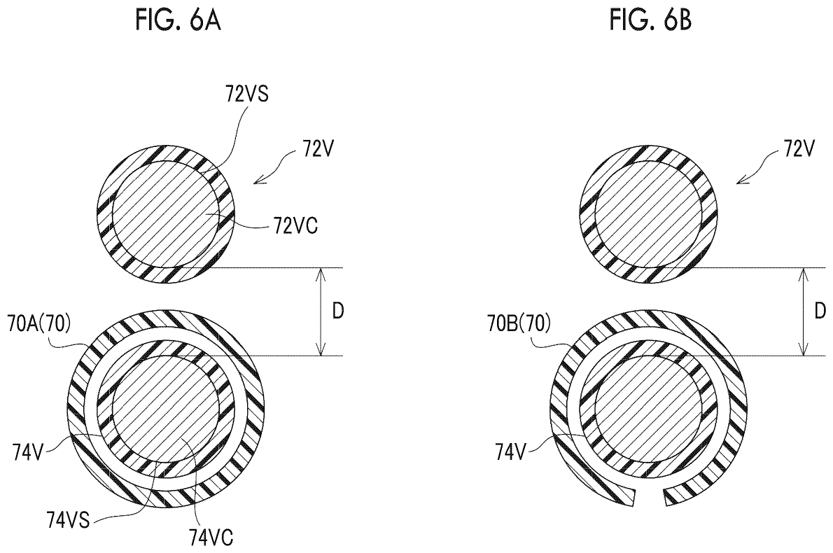

As illustrated in FIG. 6A, the shielding material 70A (70) is a resin formed in a tubular shape. In the present exemplary embodiment, the shielding material 70A (70) is a heat-insulating tube. An inner diameter of the shielding material 70A is larger than an outer diameter of the wiring line 74. In other words, at least a gap is provided between an inner circumferential surface of the shielding material 70A and an outer circumferential surface of the wiring line 74.

In addition, the shielding material 70A separates the wiring line 72V and the wiring line 74V by a distance which is equal to or longer than a predetermined distance D. The distance D refers to a distance from an outer surface 72VS of a conductor portion 72VC in the wiring line 72V to an outer surface 74VS of a conductor portion 74VC in the wiring line 74V. For example, the distance D is set to 3.5 mm or longer.

### Actions and Effects

Next, actions and effects of the second exemplary embodiment will be described.

In the image forming apparatus 110 according to the second exemplary embodiment, in addition to the actions and effects of the same configurations as the configurations of the image forming apparatus 10 according to the first exemplary embodiment, the following actions and effects can be obtained.

In a case where the wiring line 72 and the wiring line 74 are disposed side by side, an electrostatic induction voltage from the wiring line 72 to the wiring line 74 is generated according to a length of a section in which the wiring line 72 and the wiring line 74 are disposed side by side. In addition, in a case where the wiring line 72 and the wiring line 74 are in proximity to each other and a distance between the wiring line 72 and the wiring line 74 is shorter than a distance D, an electrostatic induction voltage is generated from the wiring line 72 to the wiring line 74 according to the proximity distance. In a case where an electrostatic induction voltage is generated, induction noise is generated, and the output image may be affected (defected).

Therefore, the image forming apparatus 110 further includes a wiring line 72V that connects the power supply 68A for outputting a voltage having the frequency f2 and the charging device 22V, a wiring line 74V that connects the power supply 68B for outputting the voltage having a frequency f4 different from the frequency f2 and the developing device 24V, and a separation structure that separates the wiring line 72V and the wiring line 74V from each other by a distance which is equal to or longer than a predetermined distance D. With the image forming apparatus 10 according to the first exemplary embodiment, a deterioration in the image quality of the special color is prevented as compared with a configuration in which the wiring line 72V and the wiring line 74V are in proximity to each other and a distance between the wiring line 72V and the wiring line 74V is shorter than a predetermined distance D.

In addition, in the image forming apparatus 110, the separation structure includes the shielding material 70 that is disposed between the wiring line 72V and the wiring line 74V. According to this configuration, a state where the wiring line 72V and the wiring line 74V are separated from each other may be maintained.

Although details of a certain exemplary embodiment of the present invention has been described, the present invention is not limited to such an exemplary embodiment, and it is clear for those skilled in the art that adopting other various exemplary embodiments within the scope of the present invention is possible.

### Modification Example

The distance D between the wiring line 72V and the wiring line 74V in the image forming apparatus 110 may be maintained by, for example, supporting the wiring line 72V and the wiring line 74V on the housing with a support member such as a band clip in a state where the wiring line 72V and the wiring line 74V are separated from each other, or a thickness of the shielding material 70A may be set to a thickness which is equal to or thicker than D.

The shielding material 70 is a resin formed in a tubular shape. On the other hand, the present invention is not limited thereto. For example, as illustrated in FIG. 6B, the shielding material 70 may be a sheet-shaped plastic resin shielding material 70B that is wound around the outer circumference of the wiring line 74V, or may be a band-shaped resin tape that is wound around the outer circumference of the wiring line 74V. Further, the shielding material 70 may be formed to separate the wiring line 72V and the wiring line 74V from each other by a distance which is equal to or longer than a predetermined distance, and may be, for example, a spacer disposed between the wiring line 72V and the wiring line 74V.

The shielding material 70 may be disposed in the entire section in which the wiring line 72V and the wiring line 74V are disposed side by side. In a state where the section is divided into a plurality of small sections, the shielding material 70 may be disposed in some or all of the divided sections.

### APPENDIX

(((1)))

An image forming apparatus comprising:
a first charging unit that charges a first image holding body by applying a voltage in which an AC component has a first frequency to the first image holding body;
a first developing unit that develops a latent image formed on the first image holding body by using a reference-color toner;
a second charging unit that charges a second image holding body by applying a voltage in which an AC component has a second frequency different from the first frequency to the second image holding body; and
a second developing unit that develops a latent image formed on the second image holding body by using a special-color toner.
   (((2)))

The image forming apparatus according to (((1))),
wherein the second charging unit applies a voltage having the second frequency higher than the first frequency to the second image holding body.
   (((3)))

The image forming apparatus according to (((1))) or (((2))),
wherein the first developing unit develops the latent image by applying a voltage in which an AC component has a third frequency, and
the second developing unit develops the latent image by applying a voltage in which an AC component has a fourth frequency different from the third frequency.
   (((4)))

The image forming apparatus according to (((3))),
wherein the second developing unit develops the latent image by applying a voltage having the fourth frequency lower than the third frequency.

(5)

The image forming apparatus according to any one of (((1))) to (((4))), further comprising:
a first wiring line that connects a power supply for outputting the voltage having the second frequency and the second charging unit;
a second wiring line that connects a power supply for outputting the voltage having a fourth frequency different from the second frequency and the second developing unit; and
a separation structure that separates the first wiring line and the second wiring line from each other by a distance which is equal to or longer than a predetermined distance.
   (((6)))

The image forming apparatus according to (((5))),
wherein the separation structure includes a spacer disposed between the first wiring line and the second wiring line.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first charging unit that charges a first image holding body by applying a voltage in which an AC component has a first frequency to the first image holding body;
a first developing unit that develops a latent image formed on the first image holding body by using a reference-color toner;
a second charging unit that charges a second image holding body by applying a voltage in which an AC component has a second frequency different from the first frequency to the second image holding body; and
a second developing unit that develops a latent image formed on the second image holding body by using a special-color toner.

2. The image forming apparatus according to claim 1,
wherein the second charging unit applies a voltage having the second frequency higher than the first frequency to the second image holding body.

3. The image forming apparatus according to claim 1,
wherein the first developing unit develops the latent image by applying a voltage in which an AC component has a third frequency, and
the second developing unit develops the latent image by applying a voltage in which an AC component has a fourth frequency different from the third frequency.

4. The image forming apparatus according to claim 2,
wherein the first developing unit develops the latent image by applying a voltage in which an AC component has a third frequency, and
the second developing unit develops the latent image by applying a voltage in which an AC component has a fourth frequency different from the third frequency.

5. The image forming apparatus according to claim 3,
wherein the second developing unit develops the latent image by applying a voltage having the fourth frequency lower than the third frequency.

6. The image forming apparatus according to claim 4,
wherein the second developing unit develops the latent image by applying a voltage having the fourth frequency lower than the third frequency.

7. The image forming apparatus according to claim 1, further comprising:
a first wiring line that connects a power supply for outputting the voltage having the second frequency and the second charging unit;
a second wiring line that connects a power supply for outputting the voltage having a fourth frequency different from the second frequency and the second developing unit; and
a separation structure that separates the first wiring line and the second wiring line from each other by a distance which is equal to or longer than a predetermined distance.

8. The image forming apparatus according to claim 7,
wherein the separation structure includes a spacer disposed between the first wiring line and the second wiring line.
